(19) United States
(12) Patent Application Publication
(10) Pub. No.: US 2025/0039840 A1
(43) Pub. Date: Jan. 30, 2025

(54) ACTIVE RADIO NOTIFICATION FOR PAGING

(71) Applicant: Lenovo (Singapore) Pte. Limited, Singapore (SG)

(72) Inventors: Shwetha Sreejith, Steinbach (DE); Joachim Löhr, Wiesbaden (DE); Prateek Basu Mallick, Dreieich (DE); Karthikeyan Ganesan, Kronberg Im Taunus (DE)

(73) Assignee: Lenovo (Singapore) Pte. Limited, Singapore (SG)

(21) Appl. No.: 18/781,709

(22) Filed: Jul. 23, 2024

Related U.S. Application Data
(60) Provisional application No. 63/515,221, filed on Jul. 24, 2023.

(51) Int. Cl. H04W 68/00; H04W 24/10; H04W 74/0833

(52) U.S. Cl. CPC H04W 68/005; H04W 24/10; H04W 74/0833

(57) ABSTRACT

Various aspects of the present disclosure relate to active radio notification for paging. An apparatus, such as a user equipment (UE), transmits a first signaling indicating a radio selected from a set of radios at the UE. The radios may include a main radio and a low-power wake-up radio. The UE may use the radios for receiving a paging indication from a network equipment (NE). The UE may monitor, in response to the first signaling, for a second signaling indicating whether the first signaling is successfully transmitted. For example, the UE may receive a message from the NE that indicates the NE successfully received the radio indication.

### RELATED APPLICATION

This application claims priority to U.S. Provisional Application Ser. No. 63/515,221 filed Jul. 24, 2023, entitled “ACTIVE RADIO NOTIFICATION FOR PAGING,” the disclosure of which is incorporated by reference herein in its entirety.

### TECHNICAL FIELD

The present disclosure relates to wireless communications, and more specifically to sending an active radio notification for paging.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A UE in a wireless communications system may operate in one or more modes, such as a radio resource control (RRC) connected mode, an RRC idle mode, or an RRC inactive mode. In the RRC connected mode, the UE and a network equipment (NE) (e.g., a base station) may establish an RRC connection, and the NE may configure the UE with parameters for communicating signaling. The RRC connection may provide for the UE and the NE to exchange signaling using a network layer protocol for an RRC layer within a radio access technology protocol stack. In the RRC idle mode, the UE may periodically monitor for downlink broadcast paging from a NE. For example, the NE may configure one or more paging occasions during which the UE wakes up and monitors for a paging message. In the RRC inactive mode, a connection between the UE and the NE may be suspended.

In some cases, the UE may be a low-power UE and may have one or more reduced capabilities relative to another UE (e.g., a high-power UE). For example, the UE may be a low-power UE due to reduced processing capabilities, reduced battery capacity, reduced communication capabilities, or the like. The UE may use multiple radios to monitor for paging messages in the RRC idle mode. For example, the UE may use a main radio when relatively geographically far from a NE and a low-power wake-up radio when relatively geographically close to a NE, where the low-power wake-up radio may use relatively less power than the main radio for exchanging signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may further include a UE for wireless communication to perform one or more reference signal measurements at a first radio of the UE, at a second radio of the UE, or both, select a radio from the first radio and the second radio in accordance with the one or more reference signal measurements satisfying a first threshold value for the first radio or the one or more reference signal measurements satisfying a second threshold value for the second radio, transmit a first signaling indicating the radio, and monitor, in response to the first signaling, for a second signaling.

In some implementations of the method and apparatuses described herein, the UE receives a first time-frequency resource, a first preamble, or both corresponding to an indication of the first radio and a second time-frequency resource, a second preamble, or both corresponding to an indication of the second radio and selects, from the first time-frequency resource, the first preamble, or both and the second time-frequency resource, the second preamble, or both, a time-frequency resource, a preamble, or both corresponding to the radio. Additionally, or alternatively, the time-frequency resource includes a random access occasion or a time-frequency resource for a random access preamble. Additionally, or alternatively, the UE transmits, using the selected time-frequency resource, the selected preamble, or both, a first message of a four-step random access procedure, where the first signaling includes the first message, and the selected radio is indicated by use of the time-frequency resource, the preamble, or both to transmit the first message. Additionally, or alternatively, the second signaling includes a second message or a fourth message of the four-step random access procedure. Additionally, or alternatively, the UE transmits, using the time-frequency resource, the preamble, or both, a first message of a contention-free random access procedure, where the first signaling includes the first message, and the selected radio is indicated by use of the time-frequency resource, the preamble, or both to transmit the first message. Additionally, or alternatively, the second signaling includes a second message of the contention-free random access procedure, the second message including one or more parameters in accordance with a random access preamble identifier corresponding to the first message.

Additionally, or alternatively, the first signaling includes a first message of a two-step random access procedure, the first message including one or more parameters dedicated to paging information. Additionally, or alternatively, the second signaling includes a second message of the two-step random access procedure or a second message of a contention-free random access procedure, the second signaling including at least one parameter associated with the paging information, and the UE receives the second message based on the monitoring, and determines that the first signaling is successfully transmitted based on comparing at least one parameter of the second message to at least one parameter of a first message of the two-step random access procedure or a first message of the contention-free random access procedure. Additionally, or alternatively, the first signaling includes a third message of a four-step random access procedure, the third message including one or more parameters dedicated to paging information. Additionally, or alternatively, the second signaling includes second message or a fourth message of the four-step random access procedure, the fourth message including at least one parameter associated with paging information.

Additionally, or alternatively, the first threshold value, the second threshold value, or both correspond to a mobility state of the UE. Additionally, or alternatively, the UE initiates a timer based on the one or more reference signal measurements satisfy the first threshold value, and performs, upon expiry of the timer, one or more additional reference signal measurements at a same radio as the one or more reference signal measurements, where transmitting the first signaling is based on the one or more additional reference signal measurements satisfying the first threshold value for a duration of the timer or the one or more additional reference signal measurements satisfying the second threshold value for the duration of the timer. Additionally, or alternatively, the radio is selected in accordance with the one or more reference signal measurements satisfying a third threshold value for the first radio or the one or more reference signal measurements satisfying a fourth threshold value for the second radio. Additionally, or alternatively, the UE initiates a timer based on transmitting the first signaling, and transmits third signaling upon expiry of the timer, the third signaling indicating an update to the selected radio, where the UE refrains from updating the selected radio for a duration of the timer.

Additionally, or alternatively, the UE receives the second signaling, where the second signaling indicates a base station successfully received the first signaling. Additionally, or alternatively, the UE receives the second signaling, where the second signaling indicates a base station unsuccessfully received the first signaling, or fails to receive the second signaling, where the failure to receive the second signaling indicates a base station unsuccessfully received the first signaling. Additionally, or alternatively, the UE transmits a retransmission of the first signaling in accordance with the second signaling. Additionally, or alternatively, the UE receives a paging indication using the selected radio based on the first signaling. Additionally, or alternatively, the first radio or the second radio include at least one of a low-power wake-up radio or a main radio.

Some implementations of the method and apparatuses described herein may further include a processor for wireless communication to perform one or more reference signal measurements at a first radio associated with the processor, at a second radio associated with the processor, or both, select a radio from the first radio and the second radio in accordance with the one or more reference signal measurements satisfying a first threshold value for the first radio or the one or more reference signal measurements satisfying a second threshold value for the second radio, transmit a first signaling indicating the radio, and monitor, in response to the first signaling, for a second signaling.

In some implementations of the method and apparatuses described herein, the time-frequency resource includes a random access occasion or a time-frequency resource for a random access preamble. Additionally, or alternatively, the processor transmits, using the selected time-frequency resource, the selected preamble, or both, a first message of a four-step random access procedure, where the first signaling includes the first message, and the selected radio is indicated by use of the time-frequency resource, the preamble, or both to transmit the first message. Additionally, or alternatively, the second signaling includes a second message or a fourth message of the four-step random access procedure. Additionally, or alternatively, the processor transmits, using the time-frequency resource, the preamble, or both, a first message of a contention-free random access procedure, where the first signaling includes the first message, and the selected radio is indicated by use of the time-frequency resource, the preamble, or both to transmit the first message. Additionally, or alternatively, the second signaling includes a second message of the contention-free random access procedure, the second message including one or more parameters in accordance with a random access preamble identifier corresponding to the first message.

Additionally, or alternatively, the first signaling includes a first message of a two-step random access procedure, the first message including one or more parameters dedicated to paging information. Additionally, or alternatively, the second signaling includes a second message of the two-step random access procedure, the second signaling including at least one parameter associated with the paging information, and the processor receives the second message based on the monitoring and determines that the first signaling is successfully transmitted based on comparing at least one parameter of the second message to at least one parameter of the first message. Additionally, or alternatively, the first signaling includes a third message of a four-step random access procedure, the third message including one or more parameters dedicated to paging information. Additionally, or alternatively, the second signaling includes a second message or a fourth message of the four-step random access procedure, the fourth message including at least one parameter associated with paging information.

Additionally, or alternatively, the first threshold value, the second threshold value, or both correspond to a mobility state associated with the processor. Additionally, or alternatively, the processor initiates a timer based on the one or more reference signal measurements satisfy the first threshold value, and performs, upon expiry of the timer, one or more additional reference signal measurements at a same radio as the one or more reference signal measurements, where transmitting the first signaling is based on the one or more additional reference signal measurements satisfying the first threshold value for a duration of the timer or the one or more additional reference signal measurements satisfying the second threshold value for the duration of the timer. Additionally, or alternatively, the radio is selected in accordance with the one or more reference signal measurements satisfying a third threshold value for the first radio or the one or more reference signal measurements satisfying a fourth threshold value for the second radio. Additionally, or alternatively, the processor initiates a timer based on transmitting the first signaling, and transmits third signaling upon expiry of the timer, the third signaling indicating an update to the selected radio, where the processor refrains from updating the selected radio for a duration of the timer.

Additionally, or alternatively, the processor receives the second signaling, where the second signaling indicates a base station successfully received the first signaling. Additionally, or alternatively, the processor receives the second signaling, where the second signaling indicates a base station unsuccessfully received the first signaling, or fails to receive the second signaling, where the failure to receive the second signaling indicates a base station unsuccessfully received the first signaling. Additionally, or alternatively, the processor transmits a retransmission of the first signaling in accordance with the second signaling. Additionally, or alternatively, the processor receives a paging indication using the selected radio based on the first signaling. Additionally, or alternatively, the first radio or the second radio include at least one of a low-power wake-up radio or a main radio.

Some implementations of the method and apparatuses described herein may further include a method performed by a UE, the method including performing one or more reference signal measurements at a first radio of the UE, at a second radio of the UE, or both, selecting a radio from the first radio and the second radio in accordance with the one or more reference signal measurements satisfying a first threshold value for the first radio or the one or more reference signal measurements satisfying a second threshold value for the second radio, transmitting a first signaling indicating the radio, and monitoring, in response to the first signaling, for a second signaling.

In some implementations of the method and apparatuses described herein, the time-frequency resource includes a random access occasion or a time-frequency resource for a random access preamble. Additionally, or alternatively, the method further includes transmitting, using the selected time-frequency resource, the selected preamble, or both, a first message of a four-step random access procedure, where the first signaling includes the first message, and the selected radio is indicated by use of the time-frequency resource, the preamble, or both to transmit the first message. Additionally, or alternatively, the second signaling includes a second message or a fourth message of the four-step random access procedure. Additionally, or alternatively, the method further includes transmitting, using the time-frequency resource, the preamble, or both, a first message of a contention-free random access procedure, where the first signaling includes the first message, and the selected radio is indicated by use of the time-frequency resource, the preamble, or both to transmit the first message. Additionally, or alternatively, the second signaling includes a second message of the contention-free random access procedure, the second message including one or more parameters in accordance with a random access preamble identifier corresponding to the first message.

Additionally, or alternatively, the first signaling includes a first message of a two-step random access procedure, the first message including one or more parameters dedicated to paging information. Additionally, or alternatively, the second signaling includes a second message of the two-step random access procedure, the second signaling including at least one parameter associated with the paging information, and the method further includes receiving the second message based on the monitoring and determines that the first signaling is successfully transmitted based on comparing at least one parameter of the second message to at least one parameter of the first message. Additionally, or alternatively, the first signaling includes a third message of a four-step random access procedure, the third message including one or more parameters dedicated to paging information. Additionally, or alternatively, the second signaling includes a second message or a fourth message of the four-step random access procedure, the fourth message including at least one parameter associated with paging information.

Additionally, or alternatively, the first threshold value, the second threshold value, or both correspond to a mobility state associated of the UE. Additionally, or alternatively, the method further includes initiating a timer based on the one or more reference signal measurements satisfy the first threshold value, and performing, upon expiry of the timer, one or more additional reference signal measurements at a same radio as the one or more reference signal measurements, where transmitting the first signaling is based on the one or more additional reference signal measurements satisfying the first threshold value for a duration of the timer or the one or more additional reference signal measurements satisfying the second threshold value for the duration of the timer. Additionally, or alternatively, the radio is selected in accordance with the one or more reference signal measurements satisfying a third threshold value for the first radio or the one or more reference signal measurements satisfying a fourth threshold value for the second radio. Additionally, or alternatively, the method further includes initiating a timer based on transmitting the first signaling, and transmitting third signaling upon expiry of the timer, the third signaling indicating an update to the selected radio, where the UE refrains from updating the selected radio for a duration of the timer.

Additionally, or alternatively, the method further includes receiving the second signaling, where the second signaling indicates a base station successfully received the first signaling. Additionally, or alternatively, the method further includes receiving the second signaling, where the second signaling indicates a base station unsuccessfully received the first signaling, or fails to receive the second signaling, where the failure to receive the second signaling indicates a base station unsuccessfully received the first signaling. Additionally, or alternatively, the method further includes transmitting a retransmission of the first signaling in accordance with the second signaling. Additionally, or alternatively, the method further includes receiving a paging indication using the selected radio based on the first signaling. Additionally, or alternatively, the first radio or the second radio include at least one of a low-power wake-up radio or a main radio.

Some implementations of the method and apparatuses described herein may further include a base station for wireless communication to receive a first signaling indicating a radio selected from a first radio at a user equipment (UE) and a second radio at the UE, the radio selected based at least in part on one or more reference signal measurements satisfying a first threshold value for the first radio or the one or more reference signal measurements satisfying a second threshold value for the second radio and transmit, in response to the first signaling, a second signaling.

In some implementations of the method and apparatuses described herein, the base station receives, using the first time-frequency resource, the first preamble, the second time-frequency resource, or the second preamble, a first message of a four-step random access procedure, where the first signaling includes the first message, and the selected radio is indicated by use of the first time-frequency resource, the first preamble, the second time-frequency resource, or the second preamble, to receive the first message. Additionally, or alternatively, the second signaling includes a second message or a fourth message of the four-step random access procedure.

Additionally, or alternatively, the base station receives, using the first time-frequency resource, the first preamble, the second time-frequency resource, or the second preamble, a first message of a contention-free random access procedure, where the first signaling includes the first message, and the selected radio is indicated by use of the first time-frequency resource, the first preamble, the second time-frequency resource, or the second preamble to receive the first message. Additionally, or alternatively, the second signaling includes a second message of the contention-free random access procedure, the second message including one or more parameters in accordance with a random access preamble identifier corresponding to the first message. Additionally, or alternatively, the time-frequency resource includes a random access occasion or a time-frequency resource for a random access preamble.

Additionally, or alternatively, the first signaling includes a first message of a two-step random access procedure, the first message including one or more parameters dedicated to paging information. Additionally, or alternatively, the second signaling includes a second message of the two-step random access procedure, the second signaling including at least one parameter associated with the paging information. Additionally, or alternatively, the first signaling includes a third message of a four-step random access procedure, the third message including one or more parameters dedicated to paging information. Additionally, or alternatively, the second signaling includes a second message or a fourth message of the four-step random access procedure, the fourth message including at least one parameter associated with the paging information.

Additionally, or alternatively, the base station receives third signaling upon expiry of a timer, the third signaling indicating an update to the selected radio. Additionally, or alternatively, the base station cancels a radio resource control connection setup with the UE based at least in part on receiving the first signaling. Additionally, or alternatively, the base station transmits the paging indication to the selected radio based at least in part on the first signaling. Additionally, or alternatively, the set of radios includes a low-power wake-up radio and a main radio.

### BRIEF DESCRIPTION OF THE DRAWINGS

FIGS. 1 and 2 illustrate examples of wireless communications systems in accordance with aspects of the present disclosure.

FIGS. 3 and 4 illustrate examples of signaling diagrams, in accordance with aspects of the present disclosure.

FIGS. 4 through 6 illustrate examples of transmission diagrams, in accordance with aspects of the present disclosure.

FIGS. 7 and 8 illustrate examples of RRC configurations, in accordance with aspects of the present disclosure.

FIG. 9 illustrates an example of a transmission diagram, in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of a NE in accordance with aspects of the present disclosure.

FIG. 13 illustrates a flowchart of a method performed by a UE in accordance with aspects of the present disclosure.

FIG. 14 illustrates a flowchart of a method performed by a NE in accordance with aspects of the present disclosure.

### DETAILED DESCRIPTION

A UE in a wireless communications system may have one or more reduced capabilities relative to another UE in the wireless communications system (e.g., a high-power UE). For example, the UE may be a low-power UE due to reduced processing capabilities, reduced battery capacity, reduced communication capabilities, or the like. The UE may operate in an RRC idle mode, during which the UE may periodically monitor for downlink broadcast paging from a base station. For example, the base station may configure one or more paging occasions during which the UE wakes up and monitors for a paging message. The UE periodically monitoring for the paging messages from the base station may result in a relatively high power consumption at the UE due to the UE waking up from a sleep state to monitor. The high power consumption may lead to reduced performance of the UE, especially for a low-power UE that has reduced battery capacity.

To reduce power consumption at the UE, the UE may operate using multiple radios. For example, the UE may have a main radio and a low-power wake-up radio, where the low-power wake-up radio may use relatively less power than the main radio for exchanging signaling. The low-power wake-up radio may have a relatively small geographic coverage range when compared with the main radio. Thus, the UE may use the low-power wake-up radio while the UE is in a relatively close proximity to a base station and the main radio when the UE is in a relatively far proximity from the base station. When the UE transitions out of the coverage range of the low-power wake-up radio, the UE may switch to using the main radio for exchanging signaling. However, the UE may be unable to signal which radio is preferred to receive paging messages from a base station. Thus, the base station may send paging messages to both the main radio and the low-power wake-up radio, which may be an inefficient use of communication resources and may cause high power consumption at the UE due to receiving signaling via both radios. Additionally, or alternatively, the base station may continue to send paging messages to a low-power wake-up radio after the low-power wake-up radio is out of range of the base station, which may cause the UE to lose connection with the base station.

As described herein, a UE may transmit an indication to a base station of a selected radio for receiving paging indications from the base station. For example, the UE may include the indication in a message during a random access channel (RACH) procedure (e.g., a contention-based RACH procedure or a contention free RACH (CFRA) procedure), which may also be referred to as a random access procedure. In some examples, the UE may select the main radio or the low-power wake-up radio by comparing reference signal receive power (RSRP) measurements (e.g., from a synchronization signal block (SSB) transmission) to a threshold value. The UE may send the indication of the selected radio when the UE moves out of a coverage range of the low-power wake-up radio. For example, the UE may compare a measured RSRP of the low-power wake-up radio to a threshold value to determine whether to switch to the main radio. The threshold value may be dependent upon a mobility of the UE and may account for a duration taken by the UE to wake up to monitor for the paging message. The UE may implement one or more timers to prevent the UE from frequently, or unnecessarily, switching between the low-power wake-up radio and the main radio, such as when the UE is on the edge of the coverage range of the low-power wake up radio. Additionally, or alternatively, the UE may implement one or more additional threshold values, such as hysteresis values, to prevent frequent transition of the active paging radio as well as frequent notification of the same.

Notifying the base station of the selected radio may improve power consumption at the UE. The UE may use the selected radio to monitor for paging messages from the base station and may power down the other radio. In some cases, the base station may transmit paging messages to the selected radio of the UE (e.g., rather than to both radios), which may reduce signaling overhead when compared with the unnecessary transmission of paging messages to both radios. Further, the base station may receive an indication of a new radio to transmit paging messages to when the UE moves out of a coverage range of one of the radios, which may provide for reduced signaling overhead related to loss of connection and connection reestablishment with the UE.

Aspects of the present disclosure are described in the context of a wireless communications system.

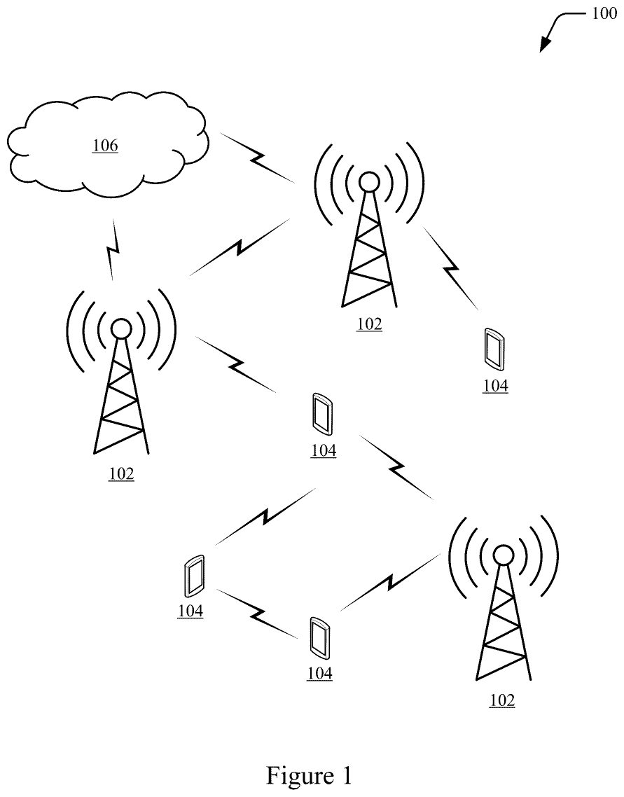

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHz-24.25 GHZ), FR4 (52.6 GHZ-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 may transmit an indication of a selected radio to a NE 102 to use for receiving paging messages from the NE 102. The NE 102 may transmit a response acknowledging the indication of the selected radio. The NE 102 may use the selected radio to transmit paging indications, paging messages, or both to the UE 104.

In some cases, to find coverage and perform cell or public land mobile network (PLMN) selection, a main radio may be switched on at a UE 104 and may remain active until radio coverage is found and a cell selection is done. If the radio quality as measured by the UE 104 (e.g., either the main radio or a low-power wake-up radio measures the radio quality) is better than a threshold value and the serving cell supports a low-power wake-up radio, a low-power wake-up radio coverage criterion is considered met. The serving cell may broadcast information explicitly and/or implicitly to indicate that the serving cell supports a low-power wake-up radio. A main radio may notify an NE 102 to page the UE 104 on an active paging radio to prevent additional power consumption by the NE caused by redundant paging.

In some cases, the notification may be performed as part of an RRC Connection establishment procedure, which may have been triggered by a NAS due to a NAS registration procedure or PDU session establishment. The notification may be performed by using a dedicated resource (e.g., one or more RACH occasions, one or more time-frequency resources, or one or more dedicated preambles). In some examples, the UE 104 may use a message in a CFRA procedure, where the message does not include information for a new RRC connection. Thus, a new RRC connection is not established if the CFRA was triggered for the purpose of paging radio notification. In some other examples, the UE 104 may include an explicit indication as part of a message in a RACH procedure.

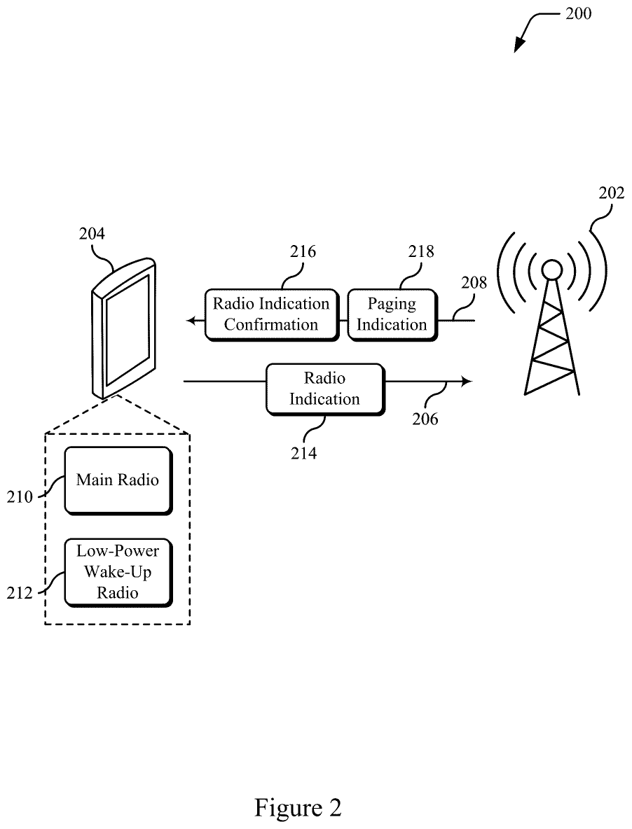

FIG. 2 illustrates an example of a wireless communications system 200 in accordance with aspects of the present disclosure. In some examples, the wireless communications system 200 may implement aspects of the wireless communications system 100. The example wireless communications system 200 includes a NE 202 and a UE 204, which may be examples of a NE 102 and a UE 104 as described with reference to FIG. 1. For example, the NE 202 may be an example of a base station. The UE 204 may transmit signaling to the NE 102 via an uplink wireless communications link 206. For example, the UE 204 may transmit data, control signaling, or both to the NE 202 via the uplink wireless communications link 206. Similarly, the NE 202 may transmit signaling to the UE 204 via a downlink wireless communications link 208. For example, the NE 202 may transmit data, control signaling, or both to the UE 204 via the downlink wireless communications link 208.

A UE 204 may have one or more reduced capabilities relative to another UE (e.g., a high-power UE). For example, the UE 204 may be a low-power UE due to reduced processing capabilities, reduced battery capacity, reduced communication capabilities, or the like. In some cases, the UE 204 may be an example of an IoT device (industrial sensor, controller, etc.), a wearable device, or another device with reduced capabilities (extended reality (XR) devices, smart phones, etc.). In some cases, a UE 204 with reduced capabilities may implement multiple radios for communicating with other wireless communications devices, such as the NE 202. The UE 204 may use a main radio 210 for attaining service from a serving radio network (e.g., the NE 202). The UE 204 may use a low-power wake-up radio 212 to offload some main radio functionality. For example, the UE 204 may use the low-power wake-up radio 212 for paging to conserve power at the UE 204. The low-power wake-up radio 212 may use a reduced transmit power and receive power for communications, but therefore may also have a reduced geographical communication range when compared with the main radio 210. For example, the low-power wake-up radio 212 may receive a low-power wake-up signal (LP-WUS) and a low-power synchronization signal (LS-SS) from the NE 202 while within a coverage range of the NE 202. While the UE 204 uses the low-power wake-up radio 212, the main radio 210 may be in a sleep mode. However, if the UE 204 leaves a coverage range of the low-power wake-up radio 212, the UE 204 may switch to the main radio 210 for communications.

The reduced coverage range of the low-power wake-up radio 212 means that the low-power wake-up radio 212 has a reduced capability in comparison with the main radio 210. This also means that the UE 204 could frequently move in and out of the low-power wake-up radio 212 coverage range, while remaining within the main radio 210 coverage. In some cases, the UE 204 may move out of the coverage range of the low-power wake-up radio 212 while the main radio 210 is in a sleep state and the UE 204 has no data to transmit (e.g., the UE 204 may be in an RRC idle mode). The NE 202 may page the UE 204 differently depending on which radio is currently listening at the UE 204. If the UE 204 goes out of the low-power wake-up radio 212 coverage range without informing the NE 202, and the main radio 210 is asleep, the UE 204 may lose connectivity with the NE 202. If the UE 204 loses connectivity with the NE 202, the UE 204 may no longer be reachable, which may incur high signaling overhead due to reestablishing a connection between the UE 204 and the NE 202. Thus, the UE 204 may notify the NE 202 that the UE 204 is switching from the low-power wake-up radio 212 to the main radio 210, so that the NE 202 may be aware of how the UE 204 can be paged.

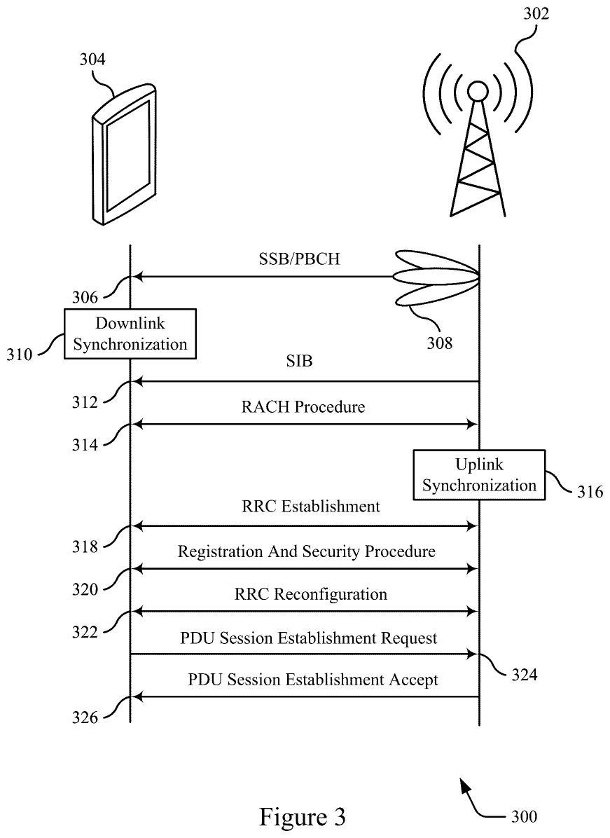

In some examples, when a UE 204 is powered on, the UE 204 may establish a connection with the NE 202, which is described in further detail with respect to FIG. 3. After establishing the connection, the UE 204 may enter an RRC idle mode if the UE 204 is not scheduled to receive data transmissions. In the RRC idle mode, the UE 204 may monitor for paging messages, such as periodically using one or more configured paging occasions. A paging occasion is a time-frequency resource the NE 202 may indicate to the UE 204 to use for waking up and monitoring for paging indications or paging messages. The UE 204 may use the main radio 210, the low-power wake-up radio 212, or both for monitoring for paging messages. However, using both radios may cause high power consumption at the UE 204 as well as high signaling overhead due to the use of time-frequency resources and power resources for communicating both transmissions when one may be sufficient. Thus, the UE 204 may select a radio for paging, which may be referred to as a paging radio. The UE 204 may use the paging radio for actively monitoring for and receiving paging indications. The UE 204 may select the low-power wake-up radio 212 when within the coverage range of the low-power wake-up radio 212 or the main radio 210 when outside of the coverage range of the low-power wake-up radio 212.

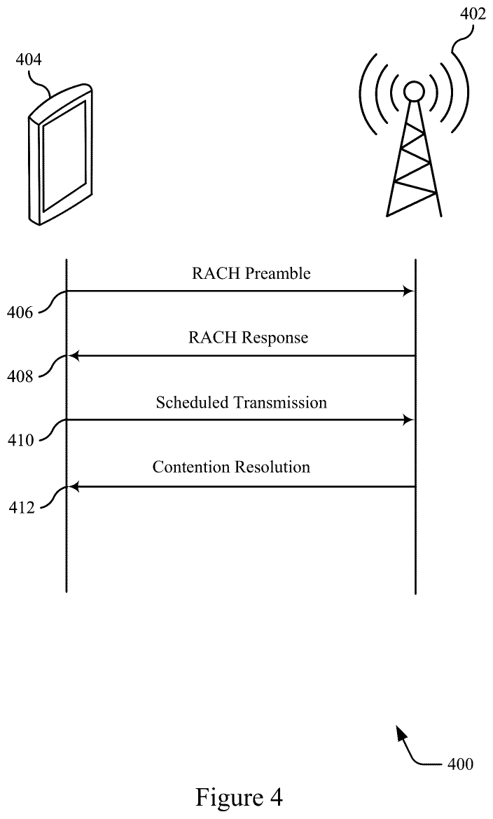

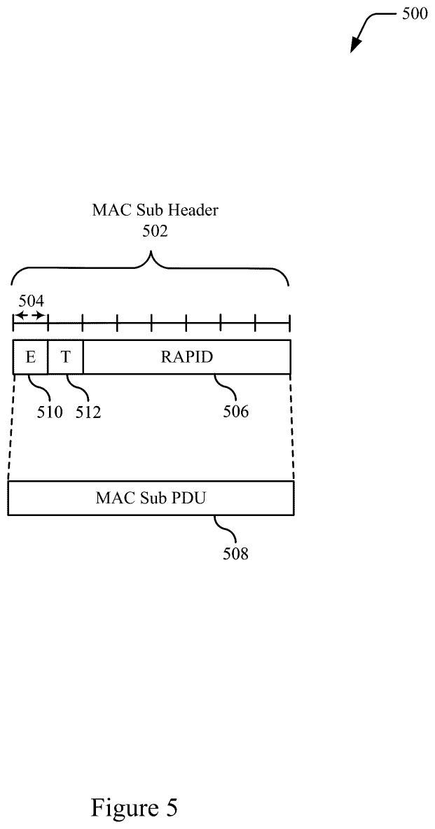

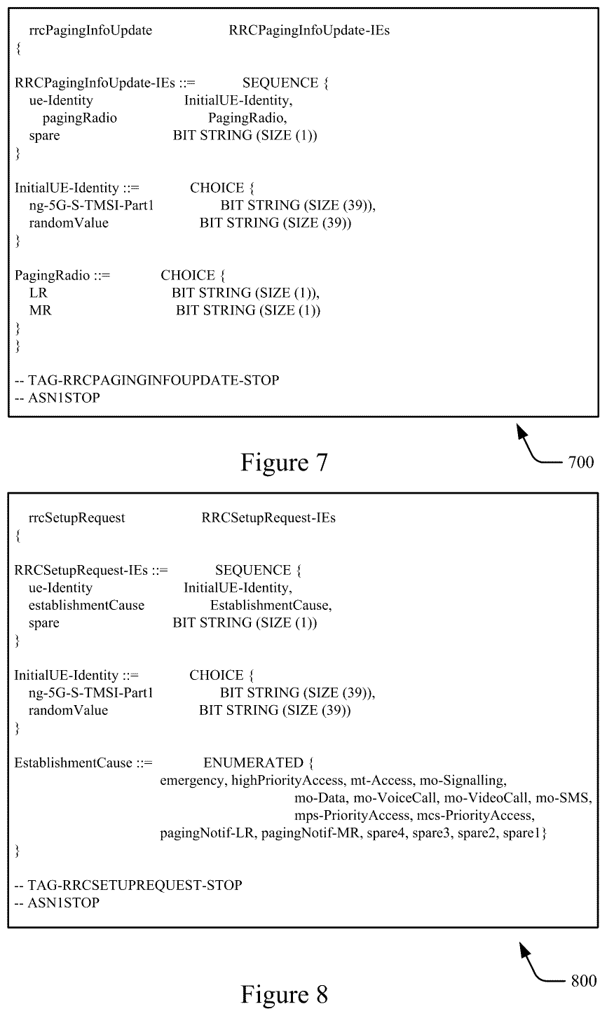

The UE 204 may transmit a radio indication 214 to the NE 202 via the uplink wireless communications link 206. For example, the UE 204 may transmit the radio indication 214 as part of a RACH procedure, such as a contention-based RACH procedure as described in further detail with respect to FIGS. 4 and 6 through 9 or a CFRA procedure as described in further detail with respect to FIG. 5. Similarly, the UE 204 may transmit the radio indication 214 as part of a two-step RACH procedure or a four-step RACH procedure. The radio indication 214 may include bits, parameters, or the like in control signaling that indicate the selected radio (e.g., the main radio 210 or the low-power wake-up radio 212), as described in further detail with respect to FIGS. 7 and 8.

In some examples, the UE 204 may select the radio and transmit the radio indication 214 when the UE 204 moves out of a coverage range of the low-power wake-up radio 212. The UE 204 may wake up the main radio 210 prior to leaving the coverage range of the low-power wake-up radio 212. The UE 204 may wake up sufficiently in advance of leaving the coverage range of the low-power wake-up radio 212, such that the main radio 210 may wake up and transmit and/or receive signaling with the NE 202. This ensures that the UE 204 may have service from the main radio 210 before the low-power wake-up radio 212 completely loses coverage. Accordingly, the UE 204 may determine a threshold value, such that when an RSRP value (e.g., as calculated by the low-power wake-up radio 212) falls below the threshold value, the UE 204 may wake up the main radio 210 and transmit the radio indication 214 to the NE 202.

In some examples, the threshold value for the RSRP may be relatively conservative. For example, if the main radio 210 takes a duration, x, (e.g., measured in ms) to wake up, downlink synchronize, and establish a connection to transmit and/or receive signaling, then the UE 204 may wake up the main radio 210 at least x plus an offset value in advance of the UE 204 leaving the coverage range for the low-power wake-up radio 212. The offset value may vary depending on the mobility state of the UE 204. The mobility state of the UE 204 may be relatively high if the UE 204 moves frequently (is on a train, in a car, etc.) or relatively low if the UE 204 is relatively stationary. Thus, the threshold value may also vary depending on the mobility state of the UE 204, such that a higher mobility of the UE 204 results in a relatively large threshold value and a lower mobility of the UE 204 results in a relatively low threshold value.

In some examples, the UE 204 may implement a timer to prevent the UE 204 from frequently, or unnecessarily, switching between the low-power wake-up radio 212 and the main radio 210, such as when the UE 204 is on the boundary of the coverage range of the low-power wake up radio 212. The timer may be a prohibit timer that is started after the transmission of the radio indication 214. While the timer is running, the UE 204 may not transmit any new radio indications 214 and may continue to receive paging on the active radio. When the timer expires, the UE 204 may transmit a new radio indication 214 to the NE 202, if and when the UE 204 transitions to a secondary radio (e.g., the radio where paging was not being received), provided the radio criteria are met. The radio criteria may include the UE 204 being located within a coverage range of the radio.

Once the UE 204 transmits the new radio indication 214, the UE 204 may switch an initial radio to a sleep mode. For example, if the UE moves out of the low-power wake-up radio 212 coverage range, the UE 204 may wake up the main radio 210 and notify the NE 202 to page the UE 204 on the main radio 210. The prohibit timer is then started allowing the UE 204 to continue receiving paging on the main radio 210. In case the UE 204 is near the boundary of the low-power wake-up radio 212 coverage range, this timer prevents frequent radio indications 214 to the NE 202. Once the timer expires, the UE 204 may switch back to the low-power wake-up radio 212 and turn off the main radio 210 provided that the criteria are met for switching radios (e.g., the UE 204 does not have any data for transmission, and the UE 204 is within a coverage range of the low-power wake-up radio 212). The UE 204 may transmit a radio indication 214 indicating to the NE 202 that the UE 204 switched back to the low-power wake-up radio 212.

In some examples, the UE 204 may use the timer as a trigger, such that the UE 204 transmits the radio indication 214 when a threshold value for an RSRP is met for the duration of the timer (e.g., a time to trigger (TTT) duration). The threshold value for the RSRP being met may qualify as a radio change event (e.g., the UE 204 changes the paging radio provided conditions are met). If the threshold value is not met for the duration of the timer, the UE 204 may ignore the radio change event. That is, the UE 204 may use the timer such that the UE 204 sends the radio indication 214 once the timer runs out. The timer is started when the threshold value is fulfilled. While the timer is running, the UE 204 does not transmit a radio indication 214. Upon expiry of the timer, if the threshold value remains fulfilled, the UE 204 may transmit a radio indication 214 by means of a RACH procedure, as described in further detail with respect to FIGS. 3 through 9. For example, if the UE 204 is moving out of the coverage range of the low-power wake-up radio 212, the UE 204 may measure the downlink RSRP value. If the RSRP measured is below the threshold value, the UE 204 may wake up the main radio 210 and start the timer. If the UE 204 is near the boundary of the low-power wake-up radio 212 coverage range, this timer prevents frequent transmissions of a radio indication 214. Once the timer expires, the UE 204 measures the RSRP value once again. If this value remains below the threshold, the UE 204 then transmits a radio indication 214 (e.g., by means of a RACH procedure) to the NE 202 indicating that the UE 204 may be paged on the main radio 210. In some examples, the UE 204 may maintain the timers in either the medium access control (MAC) layer or the RRC layer.

In some cases, the UE 204 may use one or more RSRP threshold value (e.g., an RSRP of an SSB) for determining whether to select the main radio 210 or the low-power wake-up radio 212. The UE 204 may use one RSRP threshold value for both the main radio 210 and the low-power wake-up radio 212 or different RSRP threshold values for each of the main radio 210 and the low-power wake-up radio 212, respectively. In some examples, the NE 202 may broadcast an SSB for downlink synchronization, and the UE 204 may measure a power of the SSB. The NE 202 may configure an RSRP threshold value (e.g., an SSB power threshold), such that if the SSB was received with power higher than this threshold value, the UE 204 is in relatively close proximity to the NE 202. If the power is higher than the threshold value, the low-power wake-up radio 212 coverage criteria is met, and the low-power wake-up radio 212 has an active reception status. Similarly, if the SSB has a receive power lower than the RSRP threshold value (e.g., or another RSRP threshold value for the main radio 210), the UE 204 is relatively far from the NE 202. The UE 204 may use the main radio 210 to decode the SSB if the SSB has a receive power lower than the RSRP threshold value. The UE 204 may use the measurements from the SSB to determine whether the main radio 210 and/or the low-power wake-up radio 212 have an active reception status. The UE 204 may then send the radio indication 214 including an indication of an active paging radio. The notification may be triggered each time the receive power of the SSB drops below the RSRP threshold value or whenever the receive power of the SSB moves above the RSRP threshold value. For example, the radio indication 214 may indicate the main radio 210 if the RSRP of the SSB drops below the RSRP threshold value or the low-power wake-up radio 212 if the RSRP of the SSB moves above the RSRP threshold value.

In some examples, the UE 204 may determine hysteresis values for the RSRP threshold value to prevent frequent, or unnecessary, transition of the active paging radio as well as frequent notification of the transition. For example, the UE 204 may receive the SSB near the RSRP threshold value due to being located at the boundary, or edge, of the coverage range for one of the radios. The hysteresis values may include additional thresholds that add a transition buffer between the low-power wake-up radio 212 and the main radio 210. The hysteresis values and/or the RSRP threshold value may be defined by the NE 202, the UE 204, or both (e.g., preconfigured, or otherwise configured in control signaling, calculated by the UE 204, the NE 202, or both, and the like). In some cases, one hysteresis SSB power is configured at a value slightly higher than the RSRP threshold value. This ensures that once the main radio 210 is in an active transmit and/or receive state, the UE 204 does not transition back to low-power wake-up radio 212 receive state unless the UE 204 receives and decodes an SSB with a power equal to or higher than this hysteresis power value. The second hysteresis SSB power is configured at a value slightly lower than the RSRP threshold value. This ensures that once the UE 204 enters the low-power wake-up radio 212 active reception status, the UE 204 does not transition back to the main radio 210 active mode unless the UE 204 receives and decodes an SSB with a receive power lower than or equal to this second hysteresis power value, provided that the UE has no ongoing data transmissions and remains in an RRC idle mode.

In response to the radio indication 214, the NE 202 may respond with a radio indication confirmation 216. The radio indication confirmation 216 may be an explicit indication in a message of a RACH procedure or may be an implicit indication based on the value of one or more parameters in a message of a RACH procedure, which is described in further detail with respect to FIGS. 4 through 6 and 9. The UE 204 may receive a paging indication 218, or paging indication, using the main radio 210 or the low-power wake-up radio 212 in accordance with the radio indication 214. For example, the UE 204 may use the low-power wake-up radio 212 to receive the paging indication 218 if the UE 204 is within a coverage range of the low-power wake-up radio 212. In some other examples, the UE 204 may use the main radio 210 to receive the paging indication 218 if the UE 204 is outside of a coverage range of the low-power wake-up radio 212. The UE 204 may refrain from switching radios if the UE 204 is actively receiving the paging indication 218, or any other signaling.

FIG. 3 illustrates an example of a signaling diagram 300 in accordance with aspects of the present disclosure. In some examples, the signaling diagram 300 may implement aspects of the wireless communications system 100. The signaling diagram 300 may illustrate an example of a NE 302 establishing communication with a UE 304. The NE 302 may be an example of a NE 102 and the UE 304 may be an example of a UE 104 as described with reference to FIG. 1. Alternative examples of the following may be implemented, where some processes are performed in a different order than described or are not performed. In some cases, processes may include additional features not mentioned below, or further processes may be added. In some examples, the processes described as being performed by a NE 302 may additionally, or alternatively, be performed by a different wireless communications device (e.g., a UE).

At 306, a NE 302 may transmit an SSB to a UE 304, which may include a primary synchronization signal (PSS), a secondary synchronization signal (SSS) and a physical broadcast channel (PBCH) to a UE 304. The NE 302 may use one or more directional transmit beams 308 to send the SSB to the UE 304.

At 310, the UE 304 may perform downlink synchronization. For example, the UE 304 may acquire synchronization signals.

At 312, the NE 302 may transmit a system information block (SIB) that includes scheduling information for system information messages. The system information messages may include signaling for accessing a cell, performing cell re-selection, and information related to cell selection. Cell search is the procedure by which a UE 304 acquires time and frequency synchronization information from a cell and detects the cell identifier of that cell. Cell selection is the decision-making process executed by the UE 304 to choose a specific cell for the UE 304 to register on. Cell reselection is similar to cell selection except that cell reselection is executed after the UE 304 completes cell selection and enters an RRC idle mode.

At 314, the UE 304 and the NE 302 may perform a RACH procedure, which is described in further detail with respect to FIG. 4. For example, the UE 304 and the NE 302 may perform a four-step RACH procedure with four messages. In some other examples, the UE 304 and the NE 302 may perform a two-step RACH procedure with two messages. The RACH procedure may be a contention-based RACH procedure or may be a CFRA procedure. In some cases, the RACH procedure may be initiated by a NAS PDU.

At 316, the NE 302 may perform uplink synchronization. The uplink synchronization may be part of the RACH procedure. For example, once the UE 304 completes the downlink synchronization, the UE 304 may initiate access to the network by completing the uplink synchronization. This is achieved by means of the RACH procedure, which involves the UE 304 transmitting a randomly chosen preamble. The NE 302 may detect the preamble and may respond with a timing adjustment (TA). This process enables the UE 304 to align a transmission timing with the NE 302, which may provide for relatively efficient communication due to fewer communication errors from timing misalignment. The process of exchanging the SSB, SIB, and RACH signaling may refer to beam detection and uplink and/or downlink radio channel synchronization.

At 318, the UE 304 and the NE 302 may establish an RRC connection, which may set up a radio channel for communications. After establishing the RRC connection, the UE 304 may enter a RRC connected mode, an RRC idle mode, or an RRC inactive mode. In the RRC connected mode, which may also be referred to as an RRC active mode, the NE 302 and the UE 304 may exchange signaling using a network layer protocol for an RRC layer within a radio access technology protocol stack. In the RRC idle mode, the UE may periodically monitor for downlink broadcast paging from the NE 302. For example, the NE 302 may indicate one or more paging occasions to the UE 304 during which the UE 304 may wake up and monitors for a paging message. In the RRC inactive mode, a connection between the UE 304 and the NE 302 may be suspended.

At 320, the UE 304 may transmit a registration request to the NE 302, which may include a UE identifier, a UE network capability, a requested network slice, or any combination thereof. The NE 302 and the UE 304 may perform an authentication process and a security process prior to the NE 302 accepting the registration request. The registration accept may include a registration result, a network feature support for a radio access technology, an allowed network slice, or any combination thereof.

During the registration process, the UE 304 may transition to an RRC connected mode. The NE 302 may then send the UE 304 to an RRC idle mode if conditions for the RRC idle mode are satisfied (e.g., the UE 304 has no ongoing data transmissions). The UE 304 may then become available to be paged by the NE 302. Paging is the mechanism by which the NE 302 may inform the UE 304 that the NE 302 is trying to establish a connection with the UE 304 (e.g., an indication for the UE 304 to trigger an RRC connection setup). When a UE 304 receives a paging message, the UE 304 may decode the contents of the paging message and based on the paging cause the UE 304 may execute an appropriate procedure. In some cases, the UE 304 may monitor a downlink control channel (e.g., a physical downlink control channel (PDCCH)) periodically to check for the presence of a paging message. Periodically monitoring the downlink control channel may lead to a relatively significant power consumption at the UE 304, as the UE 304 wakes up during the configured paging occasions to monitor for paging.

In some cases, the UE 304 may transmit an indication to the NE 302 of a selected radio for receiving paging indications from the NE 302. For example, the UE 304 may include the indication in a message during the RACH procedure (e.g., a contention-based RACH procedure or a CFRA procedure). In some examples, the UE may select a main radio or a low-power wake up radio by comparing RSRP to a threshold value, as described with reference to FIG. 2. The UE 304 may send the indication of the selected radio when the UE 304 moves out of a coverage range of the low-power wake-up radio. For example, the UE 304 may compare a measured RSRP of the low-power wake-up radio to a threshold value to determine whether to switch to the main radio. The threshold value may be dependent upon a mobility of the UE 304 and may account for a duration taken by the UE 304 to wake up to monitor for the paging message. The UE 304 may implement one or more timers to prevent the UE 304 from frequently, or unnecessarily, switching between the low-power wake-up radio and the main radio, such as when the UE 304 is on the edge of the coverage range of the low-power wake up radio. Additionally, or alternatively, the UE 304 may implement one or more additional threshold values, such as hysteresis values, to prevent frequent transition of the active paging radio as well as frequent notification of the same.

At 322, the UE 304 and the NE 302 may perform an RRC reconfiguration in accordance with the registration and security procedure.

At 324, the UE 304 may send a PDU session establishment request to the NE 302. PDU session establishment is the process of establishing a data path between the UE 304 and the NE 302. The PDU establishment request may include a PDU session type, a protocol configuration option (PCO), a data network name (DNN), or any combination thereof.

At 326, the NE 302 may accept the PDU session establishment request. Once the PDU session establishment request is accepted, the NE 302 and the UE 304 may exchange signaling, including a data transmission. The PDU session establishment accept message may include a PDU session type, a PCO, a PDU address, quality of service (QOS) rules, a selected network slice, a DNN, or any combination thereof.

FIG. 4 illustrates an example of a signaling diagram 400 in accordance with aspects of the present disclosure. In some examples, the signaling diagram 400 may implement aspects of the wireless communications system 100 and the wireless communications system 200. The signaling diagram 400 may illustrate an example of a NE 402 performing a RACH procedure with a UE 404. The NE 402 may be an example of a NE 102 and the UE 404 may be an example of a UE 104 as described with reference to FIG. 1. Alternative examples of the following may be implemented, where some processes are performed in a different order than described or are not performed. In some cases, processes may include additional features not mentioned below, or further processes may be added. In some examples, the processes described as being performed by a NE 402 may additionally, or alternatively, be performed by a different wireless communications device (e.g., a UE).

In some examples, a UE 404 may transmit a radio indication to a NE 402 indicating a selected radio for receiving paging indications from the NE 402, as described with reference to FIG. 2. The UE 404 may include the radio indication in a message of a RACH procedure. The RACH procedure may be a four-step RACH procedure, in which the UE 404 and the NE 402 exchange four different messages.

For example, at 406, the UE 404 may transmit a first message, msg1, of the RACH procedure. The msg1 may include a RACH preamble, which the UE 404 may transmit on a physical RACH (PRACH).

At 408, the NE 402 may respond to the msg1 by sending a second message, msg2, of the RACH procedure to the UE 404. The msg2 may be a RACH response (RAR).

At 410, the UE 404 may transmit a scheduled transmission to the NE 402 as the third message, msg3, of the RACH procedure.

At 412, the NE 402 may send contention resolution information to the UE 404 as the fourth message, msg4, of the RACH procedure.

In some examples, the UE 404 may notify the NE 402 of the paging radio the UE 404 selects by means of the main radio 210 triggering a RACH procedure. This is achieved by configuring a combination of PRACH resources like a RACH occasion, time-frequency resources, preambles, or any combination thereof dedicated for indicating the paging radio. For example, the NE 402 may transmit configuration information indicating one resource for the indication of using the main radio 210 for paging and another for the indication of using the low-power wake-up radio 212 for paging. When the UE 404 is first switched on, the main radio 210 may perform the initial attach procedure. The main radio 210 may initiate cell search and downlink synchronization takes place. Once the UE 404 is downlink synchronized and cell selection criteria are met, the UE 404 may initiate a RACH procedure, if initiated by the NAS. After this, a registration procedure ensures that the UE 404 is registered with the network and can receive paging messages.

With this solution, the RACH procedure is executed as a four-step contention-based method, but the PRACH resource is dedicated for indicating the paging radio to the NE 402. That is, the NE 402 may identify the paging radio based on the dedicated PRACH resource (e.g., RACH occasion, time-frequency resource, or dedicated preambles) that the NE 402 received the RACH message on. Here, the msg1 contains the PRACH, msg2 includes a MAC RAR, msg3 includes an uplink shared channel (e.g., physical uplink shared channel (PUSCH)) resource with an RRC message (e.g., an RRCSetupRequest parameter) and the UE identification (e.g., serving temporary mobile subscriber identity (S-TMSI), if available), and msg4 resolves the contention using a contention resolution identity. The RACH process is considered successfully completed when mg4 is successfully received and decoded by the UE. That is, the UE 404 may determine the NE 402 successfully received the indication of the paging radio if the UE 404 receives the msg4. If the UE 404 fails to receive the msg2 or the msg4 from the NE 402, the UE 404 may retransmit the PRACH.

FIG. 5 illustrates an example of a transmission diagram 500 in accordance with aspects of the present disclosure. In some examples, the transmission diagram 500 may implement, or be implemented by, aspects of the wireless communications system 100, the wireless communications system 200, the signaling diagram 300, and the signaling diagram 400. The example transmission diagram 500 may be implemented by a NE and/or a UE, which may be examples of a NE 102 and a UE 104 as described with reference to FIG. 1. For example, a UE may include an indication of a paging radio in a preamble of a CFRA procedure.

In some examples, a UE may initiate communications with a NE by performing a contention-based RACH procedure or a CFRA. In a contention-based RACH procedure, a UE may select a preamble randomly from a pool of preambles shared with other UEs. Thus, the UE has a potential risk of selecting a same preamble as another UE and subsequently experiencing conflict or contention. The NE may use contention resolution mechanisms to handle this access requests. In a CFRA procedure, the NE may allocate a preamble, which may be referred to as a dedicated RACH preamble. The dedicated RACH preamble is provided to the UE via control signaling (e.g., RRC signaling or a downlink control information (DCI) message). Therefore, there is no preamble conflict between UEs. If dedicated resources are insufficient, the NE may instruct the UE to initiate a contention-based RACH procedure.

In some cases, the UE may use a contention-free RACH procedure to notify the NE of the paging radio. With contention-free RACH, the NE may provide the UE with dedicated preambles, including one for the indication of paging the UE on the low-power wake-up radio and one for the indication of paging the UE on the main radio. Here, the UE transmits a RACH preamble for a selected radio in msg1. For example, the UE may indicate the low-power wake-up radio by using a specific dedicated preamble or the main radio by using a different dedicated preamble. The preambles may be configured by the NE to correspond to each of the radios. After the UE transmits the msg1, a time period for receiving a response to the RACH preamble, a ra-Response Window, is started. When the NE receives the preamble, the NE transmits a msg2 in response to confirm the reception of RACH preamble.

In some examples, the reception of msg2 at the UE confirms that the paging radio notification (e.g., the radio indication) is received at the NE. The msg2 transmission may have a format dedicated to confirming receipt of the paging radio notification. For example, a MAC sub header 502 for the msg2 may include one or more fields that span time resources 504. The MAC sub header 502 may include a RACH preamble identifier (RAPID) value field 506, which indicates the preamble index that was received in msg1. In some examples, the RACH preamble may also include an extension field 510, E, used to indicate whether this MAC sub PDU is the last one in a string and a type field 512, T, used to indicate whether the MAC sub header 502 is a RAPID sub header or a backoff indicator (BI) sub header. If the RAPID in the MAC sub header 502 of a MAC sub PDU 508 corresponds to one of the RACH preambles configured for a paging notification, a MAC RAR is not included in the MAC sub PDU 508. Upon reception of msg2 by the UE, the RACH procedure is considered successfully completed, and the NE is notified of the paging radio. In some examples, if the UE fails to receive the msg2, the UE may retransmit a msg transmission to indicate the paging radio notification to the NE.

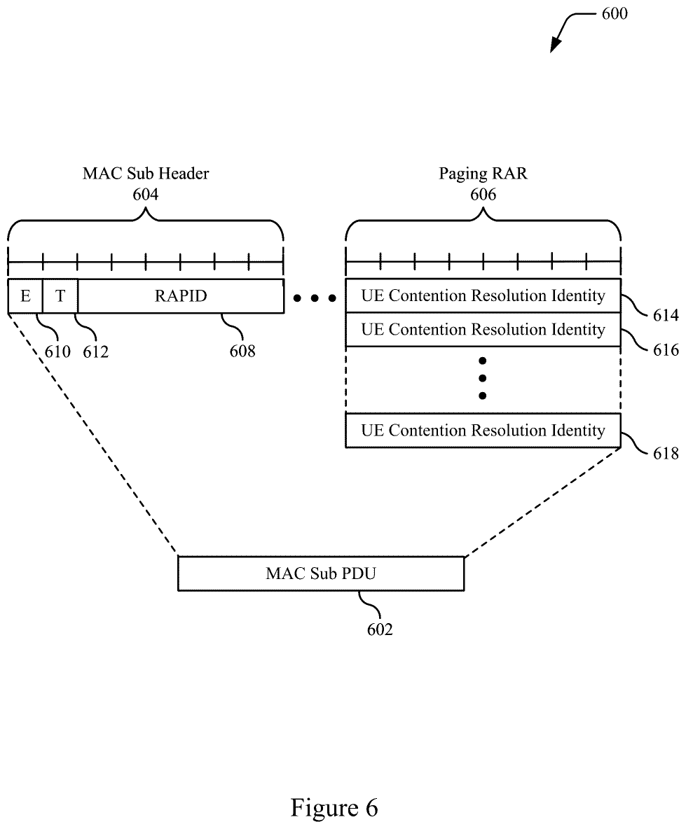

FIG. 6 illustrates an example of a transmission diagram 600 in accordance with aspects of the present disclosure. In some examples, the transmission diagram 600 may implement, or be implemented by, aspects of the wireless communications system 100, the wireless communications system 200, the signaling diagram 300, the signaling diagram 400, and the transmission diagram 500. The example transmission diagram 600 may be implemented by a NE and/or a UE, which may be examples of a NE 102 and a UE 104 as described with reference to FIG. 1. For example, a UE may include an indication of a paging radio in a message of a two-step RACH procedure.

In some examples, a UE may initiate communications with a NE by performing a two-step RACH procedure, which includes a first message, msgA, and a second message, msgB. The UE transmits the msgA to a NE, and the NE responds with the msgB. In some examples, the UE may be in an RRC idle mode after performing cell selection. The UE may remain in the RRC idle mode while performing the two-step RACH procedure. Thus, the UE may notify the NE of the paging radio without transitioning to RRC connected mode.

The UE may transmit a msgA of the two-step RACH procedure to a NE. The msgA may include one or more parameters, or fields, that indicates the paging radio, which is described in further detail with respect to FIGS. 7 and 8. In some examples, the msgA may include an uplink shared channel resource (e.g., a PUSCH resource) that includes of a UE identity, a common control channel (CCCH) service data unit (SDU), and an establishment cause parameter, establishmentCause. The UE identity may include an S-TMSI, if available, or a random value. After the UE transmits the msgA, the UE starts a duration for receiving a msgB in response, msgB-Response Window. The NE may transmit a msgB to the UE upon successfully reception and decoding of the msgA. If the NE fails to successfully receive and/or decode the msgA, the NE may request retransmission of the msgA, may wait for the UE to send a retransmission of the msgA, or may otherwise indicate to the UE the failure to successfully receive and/or decode the msgA.

In some examples, the NE may transmit a MAC sub PDU 602 in the msgB. The MAC sub PDU 602 may include a MAC sub header 604 and a paging RAR 606. The MAC sub header 604 may include a RAPID value field 608 associated with the msgA preamble identifier. In some examples, the RACH preamble may also include an extension field 610, E, used to indicate whether this MAC sub PDU is the last one in a string and a type field 612, T, used to indicate whether the MAC sub header 502 is a RAPID sub header or a BI sub header. The msgB MAC payload (e.g., the paging RAR 606) may include at least one UE contention resolution identity, such as a contention resolution identity 614, a contention resolution identity 616, and a contention resolution identity 618. The msgB may include any numerical quantity of contention resolution identities. In some cases, the UE contention resolution identity field may be a fixed 48-bit size single field that replays the UE identity received in msgA. If the contention resolution identity matches the transmitted identity, the RACH procedure is considered successfully completed, and the NE is notified of the paging radio. That is, the UE may determine that msgA is successfully transmitted to the NE by comparing the contention resolution identity from the msgB to the transmitted identity of the msgA. In some examples, if the UE fails to receive a msgB, the UE may retransmit the msgA to the NE including the indication of the paging radio.

FIG. 7 illustrates an example of a RRC configuration 700 in accordance with aspects of the present disclosure. In some examples, the RRC configuration 700 may implement, or be implemented by, aspects of the wireless communications system 100, the wireless communications system 200, the signaling diagram 300, the signaling diagram 400, the transmission diagram 500, and the transmission diagram 600. The example RRC configuration 700 may be implemented by a NE and/or a UE, which may be examples of a NE 102 and a UE 104 as described with reference to FIG. 1. For example, a UE may use the RRC configuration 700 to include an indication of a paging radio in a message of a two-step RACH procedure.

In some examples, a UE may initiate communications with a NE by performing a two-step RACH procedure, which includes a first message, msgA, and a second message, msgB. The UE transmits the msgA to a NE, and the NE responds with the msgB. In some examples, the UE may include an indication of a paging radio used to receive a paging indication, or paging message, from a NE. The UE may select the paging radio, as described with reference to FIG. 2.

In some other examples, the UE may initiate communications with a NE by performing a four-step RACH procedure, which includes msg1, msg2, msg3, and msg4. The UE may include the indication of the paging radio in the msg3 transmission to a NE, as described with reference to FIG. 4.

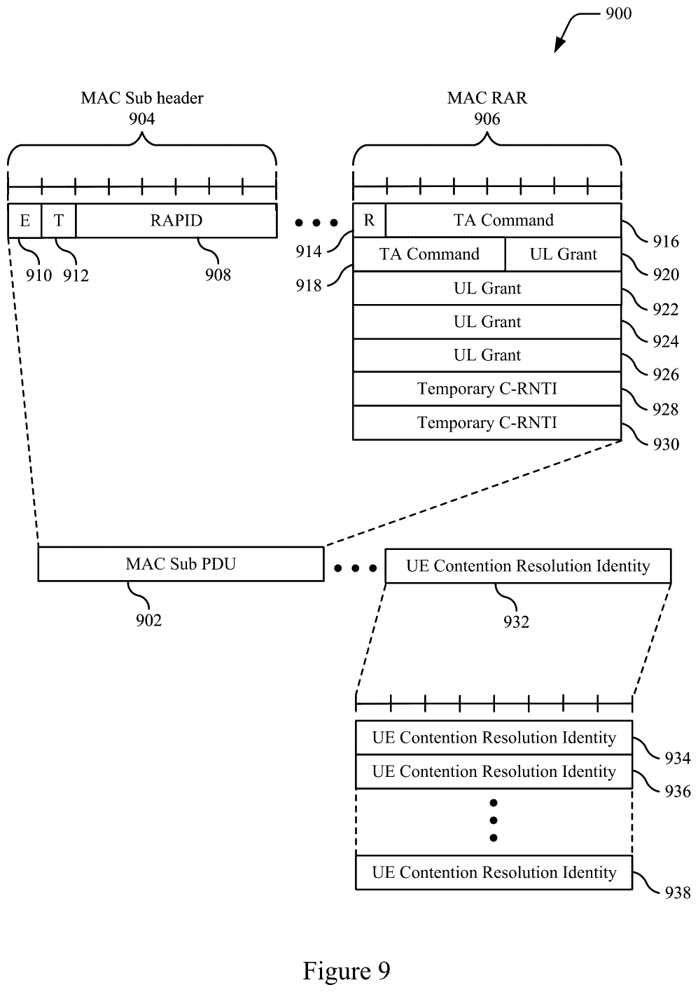

In some cases, the UE may include a new uplink CCCH RRC message in the CCH SDU of the msgA for a two-step RACH procedure or a msg3 of a four-step RACH procedure. The new uplink CCH RRC message may be referred to as a RRCPagingInfoUpdate. The new uplink CCH RRC message may inform the NE that the RACH is triggered for the purpose of a paging radio information update. The RRCPagingInfoUpdate may be a field in the msgA that includes a toggle bit. For example, the low-power wake-up radio may be denoted by the value ‘0’ and the main radio may be denoted by the value ‘1,’ where in one example, a parameter for the low-power wake-up radio, pagingNotif-LR, can take the value ‘0’ and a parameter for the main radio, pagingNotif-MR, can take the value ‘1,’ or alternatively there could be a separate denotation for the low-power wake-up radio and the main radio, respectively, that indicates whether the NE is to page the UE on the low-power wake-up radio or the main radio. The uplink shared channel (e.g., PUSCH) resource of the msgA may include a UE identity. The UE identity may include an S-TMSI, if available, which may provide for the NE to determine where (e.g., on which radio) the UE is to be paged until the NE receives a new notification and/or new information from the UE about a change of radio. The remaining RACH procedure is executed as described with reference to FIG. 6 for a two-step RACH procedure or as described in further detail with respect to FIG. 9 for a four-step RACH procedure.

FIG. 8 illustrates an example of a RRC configuration 800 in accordance with aspects of the present disclosure. In some examples, the RRC configuration 800 may implement, or be implemented by, aspects of the wireless communications system 100, the wireless communications system 200, the signaling diagram 300, the signaling diagram 400, the transmission diagram 500, and the transmission diagram 600. The example RRC configuration 800 may be implemented by a NE and/or a UE, which may be examples of a NE 102 and a UE 104 as described with reference to FIG. 1. For example, a UE may use the RRC configuration 800 to include an indication of a paging radio in a message of a two-step RACH procedure.

In some examples, a UE may initiate communications with a NE by performing a two-step RACH procedure, which includes a first message, msgA, and a second message, msgB. The UE transmits the msgA to a NE, and the NE responds with the msgB. In some examples, the UE may include an indication of a paging radio used to receive a paging indication, or paging message, from a NE. The UE may select the paging radio, as described with reference to FIG. 2.

In some other examples, the UE may initiate communications with a NE by performing a four-step RACH procedure, which includes msg1, msg2, msg3, and msg4. The UE may include the indication of the paging radio in the msg3 transmission to a NE, as described with reference to FIG. 4.

In some cases, the UE may include two new establishment cause values (e.g., pagingNotif-LR and pagingNotif-MR) in msgA for a two-step RACH procedure or in msg3 for a four-step RACH procedure to indicate which radio the NE is to use to page the UE. One of the establishment cause values may indicate the low-power wake-up radio (e.g., pagingNotif-LR), and the other value may indicate the main radio (e.g., pagingNotif-MR). The UE may transmit a msgA of the two-step RACH procedure, where the msgA includes uplink shared channel resource information including a CCCH SDU (e.g., RRCSetupRequest), an appropriate UE identification (e.g., a S-TMSI, if available), and the establishment cause values. In some cases, the NE may respond with a msgB as described with reference to FIG. 6 for a two-step RACH procedure or with a msg4 as described in further detail with respect to FIG. 9 for a four-step RACH procedure and may not execute an RRC connection setup.

FIG. 9 illustrates an example of a transmission diagram 900 in accordance with aspects of the present disclosure. In some examples, the transmission diagram 900 may implement, or be implemented by, aspects of the wireless communications system 100, the wireless communications system 200, the signaling diagram 300, the signaling diagram 400, the transmission diagram 500, the transmission diagram 600, the RRC configuration 700, and the RRC configuration 800. The example transmission diagram 900 may be implemented by a NE and/or a UE, which may be examples of a NE 102 and a UE 104 as described with reference to FIG. 1. For example, a UE may include an indication of a paging radio in a message of a four-step RACH procedure.

In some examples, a UE may initiate communications with a NE by performing a four-step contention-based RACH procedure, which includes msg1, msg2, msg3, and msg4 as described with reference to FIG. 4. The UE may transmit msg1 including a preamble index. The UE then starts the ra-ResponseWindow. Once the NE receives the msg1, the NE may transmit a msg2 back to the UE in response, where the msg2 includes a MAC sub PDU 902. The MAC sub PDU 902 may include a MAC sub header 904 and a MAC RAR 906. The MAC sub header 904 may include a RAPID value field 908, an extension field 910, E, used to indicate whether this MAC sub PDU is the last one in a string, a type field 912, T, used to indicate whether the MAC sub header 904 is a RAPID sub header or a BI sub header, or any combination thereof. In some examples, the MAC RAR 906 may include a reserved bit field 914, R, a TA command (e.g., indicated by the field 916 and the field 918), an uplink grant size (e.g., indicated by the field 920, the field 922, the field 924, and the field 926), and a temporary cell radio network temporary identifier (TC-RNTI) indicated by the field 928 and the field 930. Once the msg2 is received by the UE, the UE responds with a msg3. In some examples, the msg3 may include an uplink shared channel resource that includes the UE identity, a CCCH SDU, and an establishment cause. The msg3 may include one or more parameters, or fields, that indicate the paging radio to the NE, as described with reference to FIGS. 7 and 8. Once the NE receives the msg3, the NE then transmits the msg4 including UE contention resolution identity 932, such as the UE contention resolution identity field 934, the UE contention resolution identity 936, and the UE contention resolution identity 938. When the UE has successfully received and decoded the msg4, the RACH procedure is considered successfully completed, and the NE is notified of the paging radio. In some examples, if the UE fails to receive a msg4, the UE may retransmit the msg3 to the NE, including the indication of the paging radio.

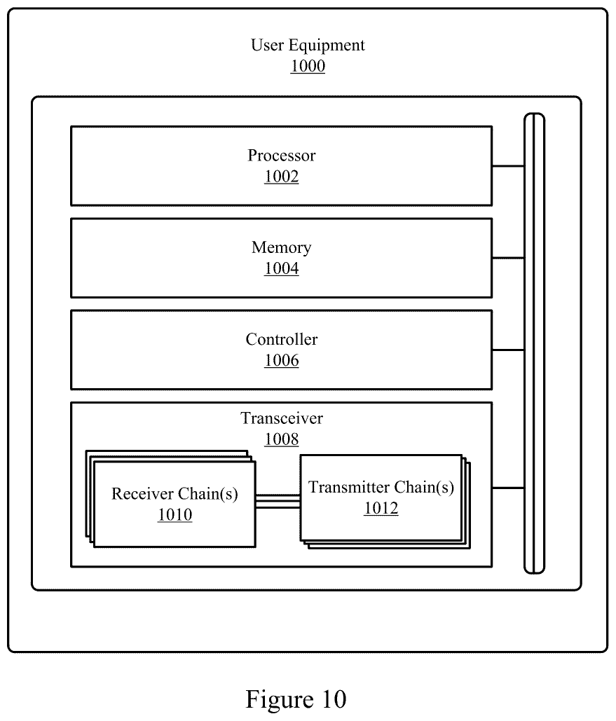

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for performing one or more reference signal measurements at a first radio of the UE, at a second radio of the UE, or both, selecting a radio from the first radio and the second radio in accordance with the one or more reference signal measurements satisfying a first threshold value for the first radio or the one or more reference signal measurements satisfying a second threshold value for the second radio, transmitting a first signaling indicating the radio, and monitoring, in response to the first signaling, for a second signaling.

Additionally, or alternatively, the UE 1000 may be configured to or operable to support means for receiving a first time-frequency resource, a first preamble, or both corresponding to an indication of the first radio and a second time-frequency resource, a second preamble, or both corresponding to an indication of the second radio and selecting, from the first time-frequency resource, the first preamble, or both and the second time-frequency resource, the second preamble, or both, a time-frequency resource, a preamble, or both corresponding to the radio.

Additionally, or alternatively, the UE 1000 may be configured to or operable to support the time-frequency resource includes a random access occasion or a time-frequency resource for a random access preamble.

Additionally, or alternatively, the UE 1000 may be configured to or operable to support means for transmitting, using the selected time-frequency resource, the selected preamble, or both, a first message of a four-step random access procedure, where the first signaling includes the first message and the selected radio is indicated by use of the time-frequency resource, the preamble, or both to transmit the first message. Additionally, or alternatively, the second signaling includes a second message or a fourth message of the four-step random access procedure.

Additionally, or alternatively, the UE 1000 may be configured to or operable to support means for transmitting, using the time-frequency resource, the preamble, or both, a first message of a contention-free random access procedure, where the first signaling includes the first message and the selected radio is indicated by use of the time-frequency resource, the preamble, or both to transmit the first message. Additionally, or alternatively, the second signaling includes a second message of the contention-free random access procedure, the second message including one or more parameters in accordance with a random access preamble identifier corresponding to the first message. In some examples, the first signaling includes a first message of a two-step random access procedure, the first message including one or more parameters dedicated to paging information.

In some examples, the second signaling includes a second message of the two-step random access procedure or a second message of a contention-free random access procedure. Additionally, or alternatively, the UE 1000 may be configured to or operable to support means for receiving the second message based on the monitoring and determining that the first signaling is successfully transmitted based on comparing at least one parameter of the second message to at least one parameter of the first message of the two-step random access procedure or a first message of the contention-free random access procedure. Additionally, or alternatively, the first signaling includes a third message of a four-step random access procedure, the third message including one or more parameters dedicated to paging information. In some examples, the second signaling includes a fourth message of a four-step random access procedure, the fourth message including at least one parameter associated with paging information.

Additionally, or alternatively, the first threshold value, the second threshold value, or both correspond to a mobility state of the UE 1000. Additionally, or alternatively, the UE 1000 may be configured to or operable to support means for initiating a timer based on the one or more reference signal measurements satisfy the first threshold value and performing, upon expiry of the timer, one or more additional reference signal measurements at a same radio as the one or more reference signal measurements, where transmitting the first signaling is based on the one or more additional reference signal measurements satisfying the first threshold value for a duration of the timer or the one or more additional reference signal measurements satisfying the second threshold value for the duration of the timer. In some examples, the radio is selected in accordance with the one or more reference signal measurements satisfying a third threshold value for the first radio or the one or more reference signal measurements satisfying a fourth threshold value for the second radio.

Additionally, or alternatively, the UE 1000 may be configured to or operable to support means for initiating a timer based on transmitting the first signaling and transmitting third signaling upon expiry of the timer, the third signaling indicating an update to the selected radio, where the UE refrains from updating the selected radio for a duration of the timer. Additionally, or alternatively, the UE 1000 may be configured to or operable to support means for monitoring for the second signaling, the monitoring including receiving the second signaling, where the second signaling indicates a base station successfully received the first signaling.

Additionally, or alternatively, the UE 1000 may be configured to or operable to support means for monitoring for the second signaling, the monitoring including receiving the second signaling, where the second signaling indicates a base station unsuccessfully received the first signaling or failing to receive the second signaling, where the failure to receive the second signaling indicates a base station unsuccessfully received the first signaling. Additionally, or alternatively, the UE 1000 may be configured to or operable to support means for transmitting a retransmission of the first signaling in accordance with the second signaling. Additionally, or alternatively, the UE 1000 may be configured to or operable to support means for receiving a paging indication using the selected radio based on the first signaling. In some examples, the first radio or the second radio include at least one of a low-power wake-up radio or a main radio.

Additionally, or alternatively, the UE 1000 may support at least one memory (e.g., the memory 1004) and at least one processor (e.g., the processor 1002) coupled with the at least one memory and configured to cause the UE to perform one or more reference signal measurements at a first radio associated with the processor, at a second radio associated with the processor, or both, select a radio from the first radio and the second radio in accordance with the one or more reference signal measurements satisfying a first threshold value for the first radio or the one or more reference signal measurements satisfying a second threshold value for the second radio, transmit a first signaling indicating the radio and monitor, in response to the first signaling, for a second signaling.

Additionally, or alternatively, the UE 1000 may be configured to support any one or combination of the at least one processor configured to receive a first time-frequency resource, a first preamble, or both corresponding to an indication of the first radio and a second time-frequency resource, a second preamble, or both corresponding to an indication of the second radio and select, from the first time-frequency resource, the first preamble, or both and the second time-frequency resource, the second preamble, or both, a time-frequency resource, a preamble, or both corresponding to the radio. Additionally, or alternatively, the UE 1000 may be configured to support the time-frequency resource includes a random access occasion or a time-frequency resource for a random access preamble. Additionally, or alternatively, the UE 1000 may be configured to support the at least one processor configured to transmit, using the selected time-frequency resource, the selected preamble, or both, a first message of a four-step random access procedure, where the first signaling includes the first message and the selected radio is indicated by use of the time-frequency resource, the preamble, or both to transmit the first message. Additionally, or alternatively, the second signaling includes a second message or a fourth message of the four-step random access procedure.

Additionally, or alternatively, the UE 1000 may be configured to support the at least one processor configured to transmit, using the time-frequency resource, the preamble, or both, a first message of a contention-free random access procedure, where the first signaling includes the first message and the selected radio is indicated by use of the time-frequency resource, the preamble, or both to transmit the first message. Additionally, or alternatively, the second signaling includes a second message of the contention-free random access procedure, the second message including one or more parameters in accordance with a random access preamble identifier corresponding to the first message. Additionally, or alternatively, the first signaling includes a first message of a two-step random access procedure, the first message including one or more parameters dedicated to paging information.

Additionally, or alternatively, the second signaling includes a second message of the two-step random access procedure or a second message of a contention-free random access procedure. Additionally, or alternatively, the UE 1000 may be configured to support the at least one processor configured to receive the second message based on the monitoring and determine that the first signaling is successfully transmitted based on comparing at least one parameter of the second message to at least one parameter of the first message of the two-step random access procedure or a first message of the contention-free random access procedure. Additionally, or alternatively, the first signaling includes a third message of a four-step random access procedure, the third message including one or more parameters dedicated to paging information. Additionally, or alternatively, the second signaling includes a second message or a fourth message of the four-step random access procedure, the fourth message including at least one parameter associated with the paging information.

Additionally, or alternatively, the first threshold value, the second threshold value, or both correspond to a mobility state of the UE. Additionally, or alternatively, the UE 1000 may be configured to support the at least one processor configured to initiate a timer based on the one or more reference signal measurements satisfy the first threshold value and perform, upon expiry of the timer, one or more additional reference signal measurements at a same radio as the one or more reference signal measurements, where transmitting the first signaling is based on the one or more additional reference signal measurements satisfying the first threshold value for a duration of the timer or the one or more additional reference signal measurements satisfying the second threshold value for the duration of the timer. In some examples, the radio is selected in accordance with the one or more reference signal measurements satisfying a third threshold value for the first radio or the one or more reference signal measurements satisfying a fourth threshold value for the second radio.

Additionally, or alternatively, the UE 1000 may be configured to support the at least one processor configured to initiate a timer based on transmitting the first signaling and transmit third signaling upon expiry of the timer, the third signaling indicating an update to the selected radio, where the UE refrains from updating the selected radio for a duration of the timer. Additionally, or alternatively, the UE 1000 may be configured to support the at least one processor configured to monitor for the second signaling, the monitoring including receiving the second signaling, where the second signaling indicates a base station successfully received the first signaling. Additionally, or alternatively, the UE 1000 may be configured to support the at least one processor configured to monitor for the second signaling, the monitoring including receiving the second signaling, where the second signaling indicates a base station unsuccessfully received the first signaling or failing to receive the second signaling, where the failure to receive the second signaling indicates a base station unsuccessfully received the first signaling. Additionally, or alternatively, the UE 1000 may be configured to support the at least one processor configured to transmit a retransmission of the first signaling in accordance with the second signaling. Additionally, or alternatively, the UE 1000 may be configured to support the at least one processor configured to receive the paging indication using the selected radio based on the first signaling. In some examples, the first radio or the second radio include at least one of a low-power wake-up radio or a main radio.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

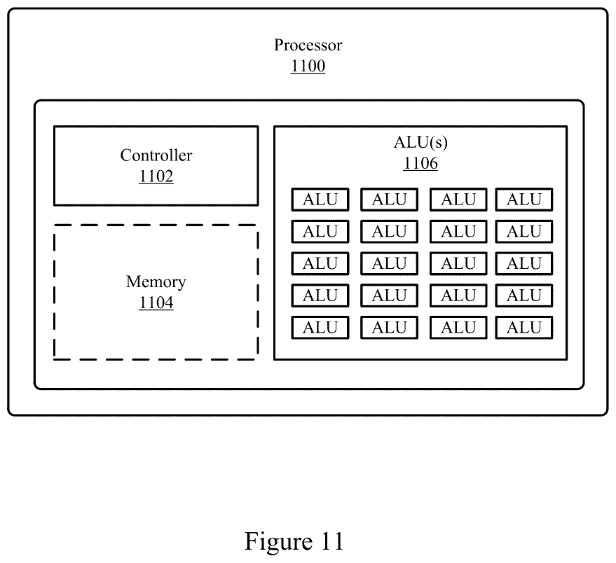

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to perform one or more reference signal measurements at a first radio associated with the processor, at a second radio associated with the processor, or both, select a radio from the first radio and the second radio in accordance with the one or more reference signal measurements satisfying a first threshold value for the first radio or the one or more reference signal measurements satisfying a second threshold value for the second radio, transmit a first signaling indicating the radio, and monitor, in response to the first signaling, for a second signaling.

Additionally, or alternatively, the processor 1100 may be configured to or operable to receive a first time-frequency resource, a first preamble, or both corresponding to an indication of the first radio and a second time-frequency resource, a second preamble, or both corresponding to an indication of the second radio and select, from the first time-frequency resource, the first preamble, or both and the second time-frequency resource, the second preamble, or both, a time-frequency resource, a preamble, or both corresponding to the radio. Additionally, or alternatively, the time-frequency resource includes a random access occasion or a time-frequency resource for a random access preamble.

Additionally, or alternatively, the processor 1100 may be configured to or operable to transmit, using the selected time-frequency resource, the selected preamble, or both, a first message of a four-step random access procedure, where the first signaling includes the first message and the selected radio is indicated by use of the time-frequency resource, the preamble, or both to transmit the first message. Additionally, or alternatively, the second signaling includes a fourth message of a four-step random access procedure. Additionally, the processor 1100 may be configured to or operable to transmit, using the time-frequency resource, the preamble, or both, a first message of a contention-free random access procedure, where the first signaling includes the first message and the selected radio is indicated by use of the time-frequency resource, the preamble, or both to transmit the first message. Additionally, or alternatively, the second signaling includes a second message of the contention-free random access procedure, the second message including one or more parameters in accordance with a random access preamble identifier corresponding to the first message.

In some examples, the first signaling includes a first message of a two-step random access procedure, the first message including one or more parameters dedicated to paging information. Additionally, or alternatively, the second signaling includes a second message of a two-step random access procedure or a second message of a contention-free random access procedure, the second signaling including at least one parameter associated with the paging information and the processor 1100 may be configured to or operable to receive the second message based on the monitoring and determine that the first signaling is successfully transmitted based on comparing at least one parameter of the second message to at least one parameter of a first message of the two-step random access procedure or a first message of the contention-free random access procedure. Additionally, or alternatively, the first signaling includes a third message of a four-step random access procedure, the third message including one or more parameters dedicated to paging information. Additionally, or alternatively, the second signaling includes a second message or a fourth message of the four-step random access procedure, the fourth message including at least one parameter associated with paging information.

Additionally, or alternatively, the first threshold value, the second threshold value, or both correspond to a mobility state of the processor. Additionally, or alternatively, the processor 1100 may be configured to or operable to initiate a timer based on the one or more reference signal measurements satisfy the first threshold value and perform, upon expiry of the timer, one or more additional reference signal measurements at a same radio as the one or more reference signal measurements, where transmitting the first signaling is based on the one or more additional reference signal measurements satisfying the first threshold value for a duration of the timer or the one or more additional reference signal measurements satisfying the second threshold value for the duration of the timer. Additionally, or alternatively, the radio is selected in accordance with the one or more reference signal measurements satisfying a third threshold value for the first radio or the one or more reference signal measurements satisfying a fourth threshold value for the second radio. Additionally, or alternatively, the processor 1100 may be configured to or operable to initiate a timer based on transmitting the first signaling and transmit third signaling upon expiry of the timer, the third signaling indicating an update to the selected radio, where the processor refrains from updating the selected radio for a duration of the timer.

Additionally, the processor 1100 may be configured to or operable to receive the second signaling, where the second signaling indicates a base station successfully received the first signaling. Additionally, or alternatively, the processor 1100 may be configured to or operable to receive the second signaling, where the second signaling indicates a base station unsuccessfully received the first signaling or fail to receive the second signaling, where the failure to receive the second signaling indicates a base station unsuccessfully received the first signaling. Additionally, or alternatively, the processor 1100 may be configured to or operable to transmit a retransmission of the first signaling in accordance with the second signaling. Additionally, the processor 1100 may be configured to or operable to receive a paging indication using the selected radio based on the first signaling. In some examples, the first radio or the second radio include at least one of a low-power wake-up radio or a main radio.

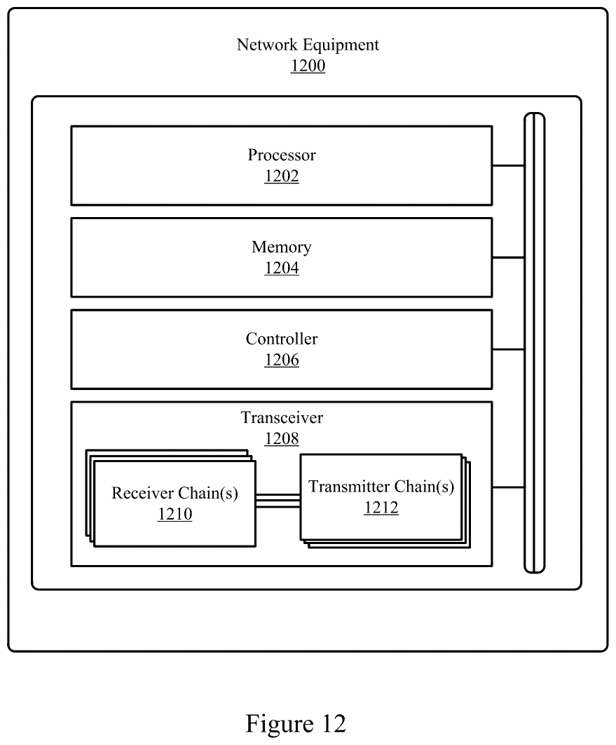

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support means for receiving a first signaling indicating a radio selected from a first radio at a user equipment (UE) and a second radio at the UE, the radio selected based at least in part on one or more reference signal measurements satisfying a first threshold value for the first radio or the one or more reference signal measurements satisfying a second threshold value for the second radio and transmitting, in response to the first signaling, a second signaling.

Additionally, or alternatively, the NE 1200 may be configured to or operable to support means for receiving, using the first time-frequency resource, the first preamble, the second time-frequency resource, or the second preamble, a first message of a four-step random access procedure, where the first signaling includes the first message and the selected radio is indicated by use of the first time-frequency resource, the first preamble, the second time-frequency resource, or the second preamble, to receive the first message. In some examples, the second signaling includes a second message or a fourth message of the four-step random access procedure.

Additionally, or alternatively, the NE 1200 may be configured to or operable to support means for receiving, using the first time-frequency resource, the first preamble, the second time-frequency resource, or the second preamble, a first message of a contention-free random access procedure, where the first signaling includes the first message and the selected radio is indicated by use of the first time-frequency resource, the first preamble, the second time-frequency resource, or the second preamble to receive the first message. In some examples, the second signaling includes a second message of the contention-free random access procedure, the second message including one or more parameters in accordance with a random access preamble identifier corresponding to the first message. Additionally, or alternatively, the time-frequency resource includes a random access occasion or a time-frequency resource for a random access preamble.

In some examples, the first signaling includes a first message of a two-step random access procedure, the first message including one or more parameters dedicated to paging information. Additionally, or alternatively, the second signaling includes a second message of the two-step random access procedure, the second signaling including at least one parameter associated with the paging information. Additionally, or alternatively, the first signaling includes a third message of a four-step random access procedure, the third message including one or more parameters dedicated to paging information. Additionally, or alternatively, the second signaling includes a second message or a fourth message of the four-step random access procedure, the fourth message including at least one parameter associated with the paging information.

Additionally, or alternatively, the NE 1200 may be configured to or operable to support means for receiving third signaling upon expiry of a timer, the third signaling indicating an update to the selected radio. Additionally, or alternatively, the NE 1200 may be configured to or operable to support means for canceling a radio resource control connection setup with the UE based on receiving the first signaling. Additionally, or alternatively, the NE 1200 may be configured to or operable to support means for transmitting the paging indication to the selected radio based on the first signaling. In some examples, the set of radios includes a low-power wake-up radio and a main radio.

Additionally, the NE 1200 may be configured to support the at least one processor coupled with the at least one memory to receive a first signaling indicating a radio selected from a first radio at a user equipment (UE) and a second radio at the UE, the radio selected based at least in part on one or more reference signal measurements satisfying a first threshold value for the first radio or the one or more reference signal measurements satisfying a second threshold value for the second radio and transmit, in response to the first signaling, a second signaling.

Additionally, or alternatively, the NE 1200 may be configured to support the at least one processor coupled with the at least one memory to receive, using the first time-frequency resource, the first preamble, the second time-frequency resource, or the second preamble, a first message of a four-step random access procedure, where the first signaling includes the first message and the selected radio is indicated by use of the first time-frequency resource, the first preamble, the second time-frequency resource, or the second preamble, to receive the first message. In some examples, the second signaling includes a second message or a fourth message of the four-step random access procedure.

Additionally, or alternatively, the NE 1200 may be configured to support the at least one processor coupled with the at least one memory to receive, using the first time-frequency resource, the first preamble, the second time-frequency resource, or the second preamble, a first message of a contention-free random access procedure, where the first signaling includes the first message and the selected radio is indicated by use of the first time-frequency resource, the first preamble, the second time-frequency resource, or the second preamble to receive the first message. In some examples, the second signaling includes a second message of the contention-free random access procedure, the second message including one or more parameters in accordance with a random access preamble identifier corresponding to the first message. Additionally, or alternatively, the time-frequency resource includes a random access occasion or a time-frequency resource for a random access preamble.

In some examples, the first signaling includes a first message of a two-step random access procedure, the first message including one or more parameters dedicated to paging information. Additionally, or alternatively, the second signaling includes a second message of the two-step random access procedure, the second signaling including at least one parameter associated with the paging information. Additionally, or alternatively, the first signaling includes a third message of a four-step random access procedure, the third message including one or more parameters dedicated to paging information. Additionally, or alternatively, the second signaling includes a second message or a fourth message of the four-step random access procedure, the fourth message including at least one parameter associated with the paging information.

Additionally, or alternatively, the NE 1200 may be configured to support the at least one processor coupled with the at least one memory to receive third signaling upon expiry of a timer, the third signaling indicating an update to the selected radio. Additionally, or alternatively, the NE 1200 may be configured to support the at least one processor coupled with the at least one memory to cancel a radio resource control connection setup with the UE based on receiving the first signaling. Additionally, or alternatively, the NE 1200 may be configured to support the at least one processor coupled with the at least one memory to transmit the paging indication to the selected radio based on the first signaling. In some examples, the set of radios includes a low-power wake-up radio and a main radio.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

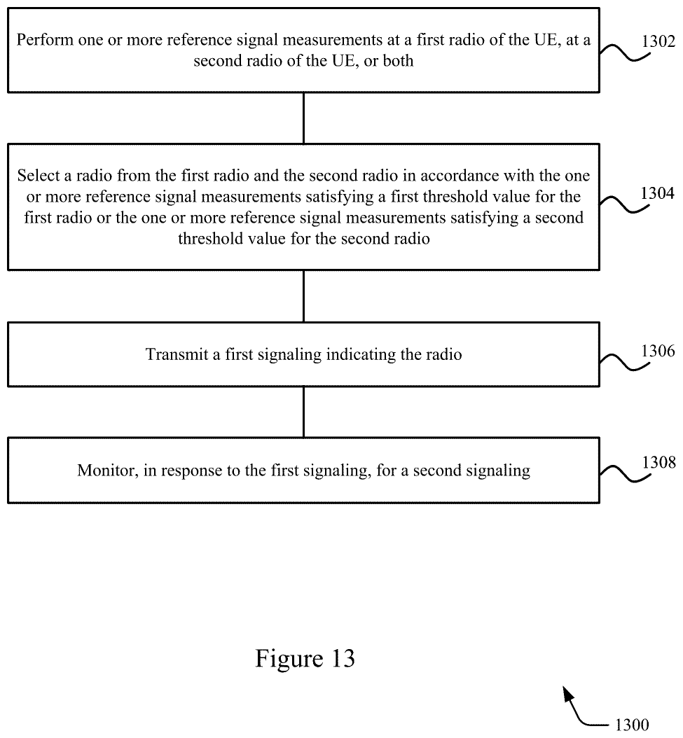

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include performing one or more reference signal measurements at a first radio of the UE, at a second radio of the UE, or both. The operations of 1302 may be performed in accordance with examples as described herein. In some implementations, aspects of the operations of 1302 may be performed by a UE as described with reference to FIG. 10.

At 1304, the method may include selecting a radio from the first radio and the second radio in accordance with the one or more reference signal measurements satisfying a first threshold value for the first radio or the one or more reference signal measurements satisfying a second threshold value for the second radio. The operations of 1304 may be performed in accordance with examples as described herein. In some implementations, aspects of the operations of 1304 may be performed by a UE as described with reference to FIG. 10.

At 1306, the method may include transmitting a first signaling indicating the radio. The operations of 1306 may be performed in accordance with examples as described herein. In some implementations, aspects of the operations of 1306 may be performed by a UE as described with reference to FIG. 10.

At 1308, the method may include monitoring, in response to the first signaling, for a second signaling. The operations of 1308 may be performed in accordance with examples as described herein. In some implementations, aspects of the operations of 1308 may be performed by a UE as described with reference to FIG. 10.

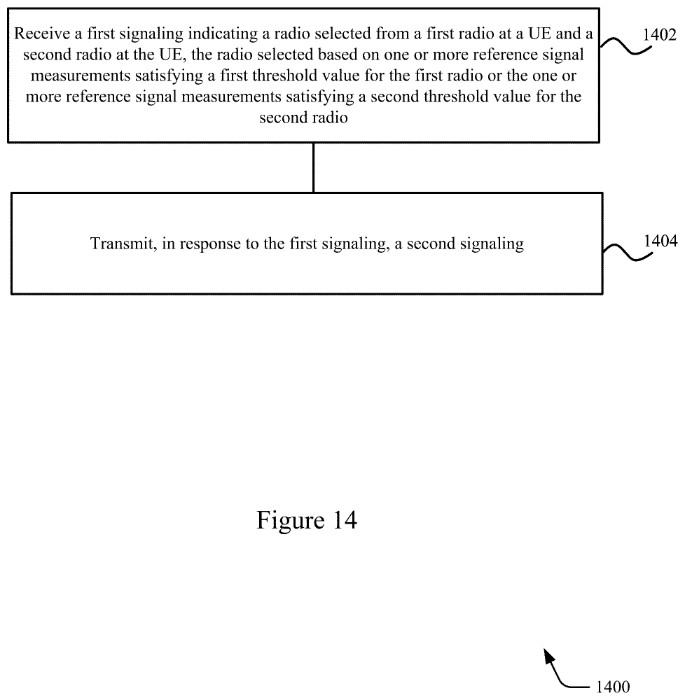

FIG. 14 illustrates a flowchart of a method 1400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include receiving a first signaling indicating a radio selected from a first radio at a UE and a second radio at the UE, the radio selected based at least in part on one or more reference signal measurements satisfying a first threshold value for the first radio or the one or more reference signal measurements satisfying a second threshold value for the second radio. The operations of 1402 may be performed in accordance with examples as described herein. In some implementations, aspects of the operations of 1402 may be performed by a NE as described with reference to FIG. 12.

At 1404, the method may include transmitting, in response to the first signaling, a second signaling. The operations of 1404 may be performed in accordance with examples as described herein. In some implementations, aspects of the operations of 1404 may be performed by a NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
perform one or more reference signal measurements at a first radio of the UE, at a second radio of the UE, or both;
select a radio from the first radio and the second radio in accordance with the one or more reference signal measurements satisfying a first threshold value for the first radio or the one or more reference signal measurements satisfying a second threshold value for the second radio;
transmit a first signaling indicating the radio; and
monitor, in response to the first signaling, for a second signaling.

2. The UE of claim 1, wherein the at least one processor is further configured to cause the UE to:
receive a first time-frequency resource, a first preamble, or both corresponding to an indication of the first radio and a second time-frequency resource, a second preamble, or both corresponding to an indication of the second radio; and
select, from the first time-frequency resource, the first preamble, or both and the second time-frequency resource, the second preamble, or both, a time-frequency resource, a preamble, or both corresponding to the radio.

3. The UE of claim 2, wherein the at least one processor is further configured to cause the UE to transmit, using the selected time-frequency resource, the selected preamble, or both, a first message of a four-step random access procedure, and wherein:
the first signaling comprises the first message; and
the selected radio is indicated by use of the time-frequency resource, the preamble, or both to transmit the first message.

4. The UE of claim 2, wherein the at least one processor is further configured to cause the UE to transmit, using the time-frequency resource, the preamble, or both, a first message of a contention-free random access procedure, and wherein:
the first signaling comprises the first message; and
the selected radio is indicated by use of the time-frequency resource, the preamble, or both to transmit the first message.

5. The UE of claim 1, wherein the first signaling comprises a first message of a two-step random access procedure, the first message comprising one or more parameters dedicated to paging information.

6. The UE of claim 1, wherein:
the second signaling comprises a second message of a two-step random access procedure or a second message of a contention-free random access procedure, the second signaling comprising at least one parameter associated with paging information; and
the at least one processor is further configured to cause the UE to:
receive the second message based at least in part on the monitoring; and
determine that the first signaling is successfully transmitted based at least in part on comparing at least one parameter of the second message to at least one parameter of a first message of the two-step random access procedure or a first message of the contention-free random access procedure.

7. The UE of claim 1, wherein the first signaling comprises a third message of a four-step random access procedure, the third message comprising one or more parameters dedicated to paging information.

8. The UE of claim 1, wherein the second signaling comprises a second message or a fourth message of a four-step random access procedure, the fourth message comprising at least one parameter associated with paging information.

9. The UE of claim 1, wherein the first threshold value, the second threshold value, or both correspond to a mobility state of the UE.

10. The UE of claim 1, wherein the at least one processor is further configured to cause the UE to:
initiate a timer based at least in part on the one or more reference signal measurements satisfy the first threshold value; and
perform, upon expiry of the timer, one or more additional reference signal measurements at a same radio as the one or more reference signal measurements, wherein transmitting the first signaling is based at least in part on the one or more additional reference signal measurements satisfying the first threshold value for a duration of the timer or the one or more additional reference signal measurements satisfying the second threshold value for the duration of the timer.

11. The UE of claim 1, wherein the radio is selected in accordance with the one or more reference signal measurements satisfying a third threshold value for the first radio or the one or more reference signal measurements satisfying a fourth threshold value for the second radio.

12. The UE of claim 1, wherein the at least one processor is further configured to cause the UE to:
initiate a timer based at least in part on transmitting the first signaling; and
transmit third signaling upon expiry of the timer, the third signaling indicating an update to the selected radio, wherein the UE refrains from updating the selected radio for a duration of the timer.

13. The UE of claim 1, wherein to monitor for the second signaling, the at least one processor is configured to cause the UE to receive the second signaling, and wherein the second signaling indicates a base station successfully received the first signaling.

14. The UE of claim 1, wherein to monitor for the second signaling, the at least one processor is configured to cause the UE to:
receive the second signaling, wherein the second signaling indicates a base station unsuccessfully received the first signaling; or
fail to receive the second signaling, wherein the failure to receive the second signaling indicates a base station unsuccessfully received the first signaling.

15. The UE of claim 14, wherein the at least one processor is further configured to cause the UE to transmit a retransmission of the first signaling in accordance with the second signaling.

16. The UE of claim 1, wherein the at least one processor is further configured to cause the UE to receive a paging indication using the selected radio based at least in part on the first signaling.

17. The UE of claim 1, wherein the first radio or the second radio comprise at least one of a low-power wake-up radio or a main radio.

18. A processor for wireless communication, comprising:
at least one controller coupled with at least one memory and configured to cause the processor to:
perform one or more reference signal measurements at a first radio associated with the processor, at a second radio associated with the processor, or both;
select a radio from the first radio and the second radio in accordance with the one or more reference signal measurements satisfying a first threshold value for the first radio or the one or more reference signal measurements satisfying a second threshold value for the second radio;
transmit a first signaling indicating the radio; and
monitor, in response to the first signaling, for a second signaling.

19. A method performed by a user equipment (UE), the method comprising:
performing one or more reference signal measurements at a first radio of the UE, at a second radio of the UE, or both;
selecting a radio from the first radio and the second radio in accordance with the one or more reference signal measurements satisfying a first threshold value for the first radio or the one or more reference signal measurements satisfying a second threshold value for the second radio;
transmitting a first signaling indicating the radio; and
monitoring, in response to the first signaling, for a second signaling.

20. A base station for wireless communication, comprising:
at least one memory; and
at least one processor coupled with the at least one memory and configured to cause the base station to:
receive a first signaling indicating a radio selected from a first radio at a user equipment (UE) and a second radio at the UE, the radio selected based at least in part on one or more reference signal measurements satisfying a first threshold value for the first radio or the one or more reference signal measurements satisfying a second threshold value for the second radio; and
transmit, in response to the first signaling, a second signaling.
